(19) United States
(12) Patent Application Publication
(10) Pub. No.: US 2025/0332720 A1
(43) Pub. Date: Oct. 30, 2025

(54) HEAVY OBJECT PRECISION ASSEMBLY DEVICE AND CONTROL METHOD

(71) Applicant: Kia Corporation, Seoul (KR)

(72) Inventors: Jae Hong Shin, Gwangmyeong-si Gyeonggi-do (KR); Yong Gil Kim, Bupyeong-gu, Incheon (KR)

(21) Appl. No.: 18/866,589

(22) PCT Filed: Dec. 20, 2022
(86) PCT No.: PCT/KR2022/020800

§ 371 Date: Nov. 18, 2024

(30) Foreign Application Priority Data
Jul. 7, 2022 (KR) 10-2022-0083840

(51) Int. Cl. B25J 9/16; B25J 15/00; B25J 15/06; B25J 17/02; B62D 65/02; B62D 65/06

(52) U.S. Cl. CPC B25J 9/1633; B25J 9/1674; B25J 9/1687; B25J 15/0052; B25J 15/0616; B25J 17/0275; B62D 65/024; B62D 65/06

(57) ABSTRACT

The present invention comprises: a gripper configured to grip a heavy object to be assembled; a cooperative robot for adjusting a location and an angle of the gripper; a balancer for supplementing loading weight of the cooperative robot and supporting the gripper; a loader arm for supporting the balancer and the cooperative robot; a servo gantry configured to support the loader arm at the upper side of an assembly object with which the heavy object is to be assembled, and enable a plane movement of the loader arm in the horizontal direction.

### TECHNICAL FIELD

The present disclosure relates to a technology that enables a heavy object such as a door of a vehicle and so on to be precisely assembled on a vehicle body and so on.

### BACKGROUND ART

When a vehicle is manufactured, a heavy object such as a door is required to be assembled to a vehicle body. Such an assembly of the door to the vehicle body is performed by accurately aligning a door fastening hole provided in the door to a hinge fastening hole of a door hinge provided on the vehicle body and then fastening a bolt.

However, since the door is a heavy object, it is impossible for a worker to directly handle the door so as to align the door fastening hole and the door hinge hole and to fasten the bolt, so that assistance of a labor-saving apparatus is required.

The labor-saving apparatus is provided with a gripper that grips a heavy object such as a door and so on. In order to produce a new vehicle model, a structure of the gripper is required to be modified according to a new door, and a new setting of the facility is required, so that a relatively long time and a high cost are required.

In addition, the labor-saving apparatus as described above automatically transports a heavy object such as a door and so on. At this time, there is a risk that a collision with a worker or an entrapment of the worker may occur.

As a related art, KR 10-1743393 B1 is provided.

### DISCLOSURE

### Technical Problem

An objective of the present disclosure is to provide a heavy object precision assembly device and a control method of the heavy object precision assembly device capable of assisting a worker so that assembly work is conveniently performed when a heavy object such as a door of a vehicle is required to be moved so as to assemble the heavy object to a precise position, the heavy object precision assembly device being capable of saving the cost and time by being configured such that modification of a gripper is capable of being avoided or minimized even when a heavy object that is an assembly object is changed, and the heavy object precision assembly device being capable of securing safety of the worker when using the heavy object precision assembly device.

### Technical Solution

In order to achieve the objectives of the present disclosure, a heavy object precision assembly device including:
a gripper configured to grip a heavy object to be assembled;
a cooperative robot configured to adjust a position and an angle of the gripper;
a balancer configured to supplement a loading weight of the cooperative robot and to support the gripper;
a loader arm configured to support the balancer and the cooperative robot; and
a servo gantry configured to support the loader arm at an upper side of an assembly object with which the heavy object is to be assembled, the servo gantry being configured to allow the loader arm to perform a planar movement in a horizontal direction
is provided.

The loader arm may have
a lower end which extends downward of the servo gantry and on which the cooperative robot is mounted, and
the loader arm may be connected to an upper side of the balancer through a plurality of rotatable linkages such that a planar movement in the horizontal direction of the balancer is capable of being performed.

The loader arm may be provided integrally with a

controller shelf on which a robot controller of the cooperative robot is mounted.

The balancer including:
a cylinder configured to support the weight of the gripper and the weight of the heavy object that is gripped by the gripper; and
an encoder configured to detect an operation position of the cylinder
may be provided.

The balancer configured to realize:
a position hold mode controlled so as to follow the operation position of the cylinder according to an input signal despite a change in an external force applied to the cylinder in real time; and
a load guided mode controlled so as to change the operation position of the cylinder according to a direction of an additional external force with respect to an already recognized external force
may be provided.

The gripper including:
a gripper base coupled to a lower side of the balancer; and
a gripper operation part connected to the gripper base by a spherical bearing, the gripper operation part being provided with a plurality of gripping apparatuses for gripping the heavy object and being connected to the cooperative robot
may be provided.

The heavy object may be a door of a vehicle, and
the plurality of gripping apparatuses may include at least one of a vacuum suction cup configured to be suctioned to glass of the door, a lower attachment configured to support a lower side of the door, and a trim attachment configured to support a trim of the door.

The gripper operation part may be provided with a tool holder for mounting a tool of a worker, the tool being used for assembling the heavy object.

The cooperative robot configured to realize:
an automatic driving mode in which the cooperative robot is automatically operated according to a command taught from a robot controller;
a direct teaching mode in which a driving force and a brake of a robot driving shaft are released such that each driving shaft is capable of being rotated by an external force; and
a force compliance control mode in which an orientation of the cooperative robot is changed according to an external force applied to the cooperative robot
may be provided.

The cooperative robot may be configured such that an operation of the cooperative robot is stopped for protecting a worker when torque applied to the driving shaft exceeds a predetermined reference value.

In addition, in order to achieve the objectives of the present disclosure, a heavy object precision assembly device control method including:
moving a loader arm toward a heavy object on a pallet by using a servo gantry;
gripping the heavy object by using a gripper supported on the loader arm;
unloading the heavy object from the pallet by using a cooperative robot;
moving, by using the servo gantry, the heavy object to an assembly object with which the heavy object is to be assembled;
adjusting, according to a control of a worker by using the cooperative robot, a position and an orientation of the heavy object gripped on the gripper, thereby aligning the heavy object to an assembly position of the assembly object; and
releasing, by using the gripper, gripping of the heavy object when an assembly of the heavy object is completed
is provided.

In addition, moving the loader arm to a predetermined home position by using the servo gantry after the releasing gripping of the heavy object by using the gripper
may further be provided.

In the gripping the heavy object by using the gripper,
when the gripper grips the heavy object, a mode of the cooperative robot may be switched from an automatic driving mode to a direct teaching mode so that a load caused by the heavy object is all applied on a balancer, and

a mode of the balancer may be switched from a load guided mode to a position hold mode so that the balancer is capable of additionally supporting the weight of the heavy object in addition to the weight of the gripper.

After the mode of the balancer is switched from the load guided mode to the position hold mode and before the unloading the heavy object from the pallet,
a position adjustment for raising the heavy object from the pallet by a predetermined amount such that the weight of the heavy object is capable of being fully supported by the balancer may be performed.

In the unloading the heavy object from the pallet,
the mode of the balancer may be switched to the load guided mode, and
the mode of the cooperative robot may be switched to the automatic driving mode, and then the heavy object may be completely unloaded from the pallet.

In the aligning the heavy object to the assembly position of the assembly object,
a mode of the cooperative robot may be switched to a force compliance control mode, so that the position and the orientation of the heavy object gripped on the gripper may be adjusted according to an external force applied by the worker.

In the releasing gripping of the heavy object by the gripper,
the mode of the cooperative robot may be switched to a direct teaching mode and a mode of a balancer is switched to a position hold mode, so that only the weight of the gripper may be supported on the balancer.

After the releasing gripping of the heavy object by the gripper, moving the loader arm to a predetermined home position by using the servo gantry may be performed, and
in the moving the loader arm to the predetermined home position,
the mode of the balancer may be switched to a load guided mode and the mode of the cooperative robot may be switched to an automatic driving mode, so that the gripper may be adjusted such that the gripper is moved to the predetermined home position.

The heavy object may be a door of a vehicle,
a vacuum suction cup that is a gripping apparatus of the gripper may be suctioned to glass of the door during the gripping the heavy object by using the gripper, and
the vacuum suction cup may be released from the glass of the door during the releasing gripping of the heavy object by using the gripper.

During performing all processes from the moving the loader arm toward the heavy object to the moving the loader arm to the home position, when torque applied to a driving shaft of the cooperative robot exceeds a predetermined reference value, an operation may be stopped for protecting the worker.

### Advantageous Effects

According to the present disclosure, assistance is provided to a worker so that assembly work is conveniently performed when a heavy object such as a door of a vehicle is required to be moved so as to assemble the heavy object to a precise position, the cost and time are saved by avoiding or minimizing a modification of a gripper even when a heavy object that is an assembly object is changed, and safety of the worker may be secured when using the heavy object precision assembly device.

### DESCRIPTION OF DRAWINGS

FIG. 1 is a view illustrating an overall configuration of a heavy object precision assembly device according to the present disclosure.

FIG. 2 is a view illustrating a configuration other than a facility frame in FIG. 1.

FIG. 3 is a view illustrating a servo gantry viewed from an upper side in FIG. 2.

FIG. 4 is a view illustrating only the servo gantry and excluding other configurations in FIG. 3.

FIG. 5 is a view illustrating a loader arm mounted on a lower side of the servo gantry and illustrating components mounted on the loader arm.

FIG. 6 is a view illustrating only the loader arm in FIG. 5.

FIG. 7 is a view illustrating the loader arm viewed from above.

FIG. 8 is a detailed view illustrating a structure of a balancer.

FIG. 9 is a detailed view illustrating a structure of a gripper.

FIG. 10 is a view illustrating a state in which a door is gripped on the gripper.

FIG. 11 is a view specifically illustrating a connection structure between a cooperative robot and the gripper.

FIG. 12 is a flowchart illustrating a heavy object precision assembly device control method according to an embodiment of the present disclosure.

FIG. 13 is a view illustrating a state in which the gripper grips the door from a pallet.

FIG. 14 is a view illustrating a state in which the door that is gripped on the gripper is transported to a vehicle body by using the servo gantry.

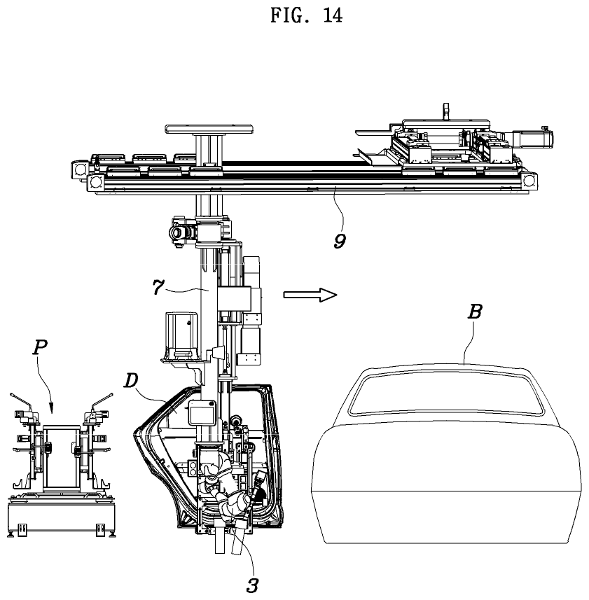

FIG. 15 is a view illustrating a state in which the door is aligned and assembled to the vehicle body with an aid of the cooperative robot.

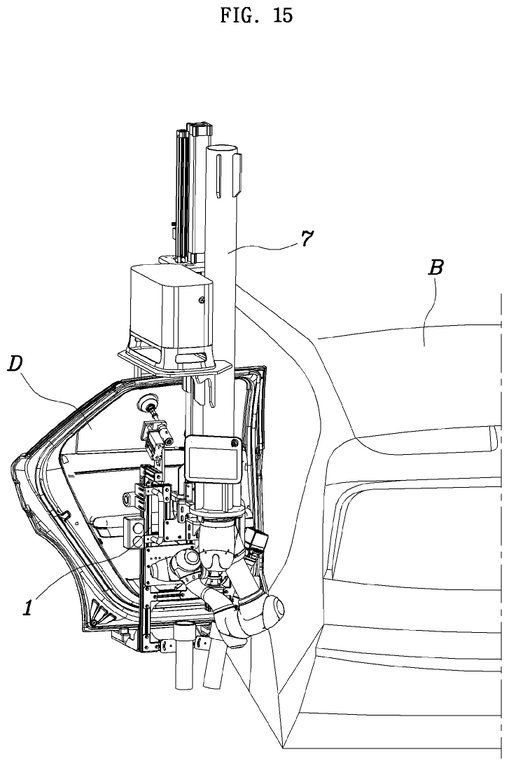

FIG. 16 is a view illustrating each operation of the cooperative robot, the balancer, the gripper, and the servo gantry when the control method in FIG. 12 is performed sequentially.

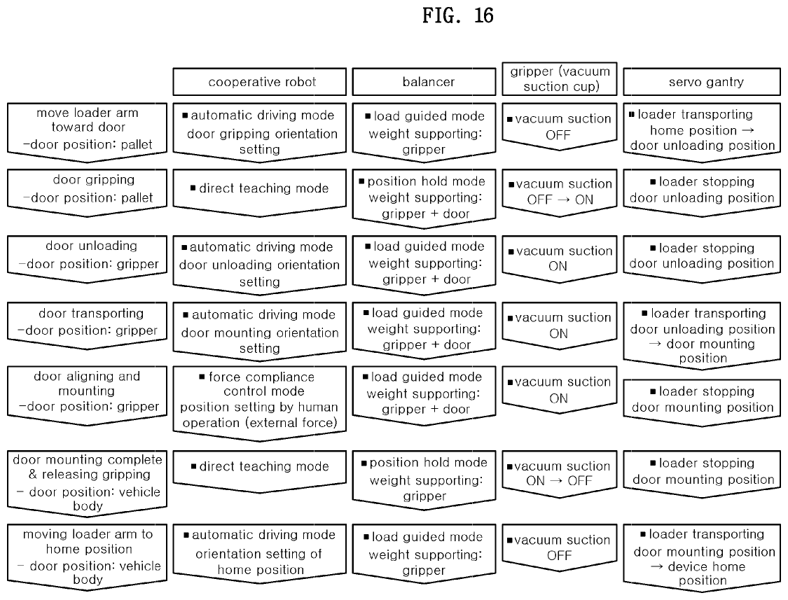

### MODE FOR INVENTION

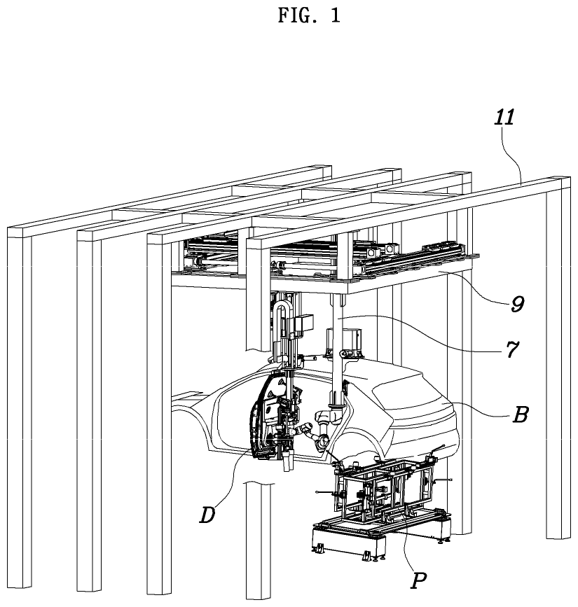

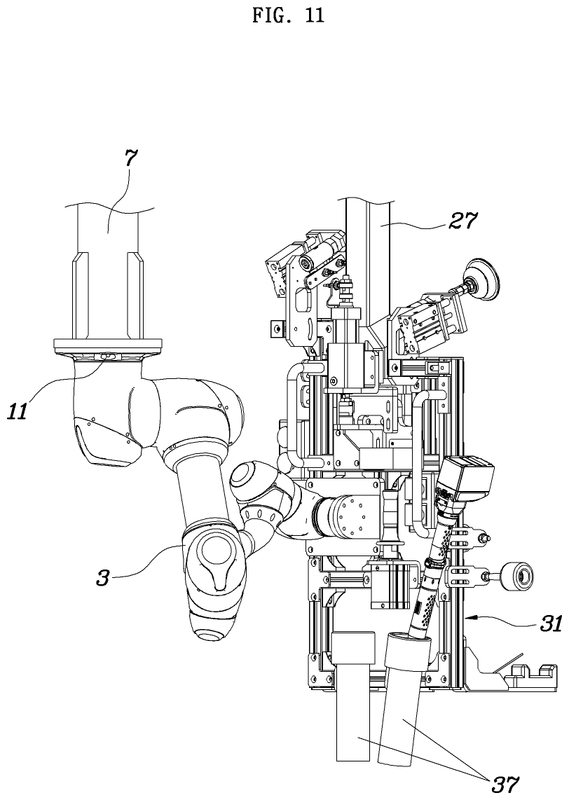

Referring to FIG. 1 to FIG. 11, a heavy object precision assembly device of the present disclosure includes: a gripper 1 configured to grip a heavy object D to be assembled; a cooperative robot 3 configured to adjust a position and an angle of the gripper 1; a balancer 5 configured to supplement loading weight of the cooperative robot 3 and to support the gripper 1; a loader arm 7 configured to support the balancer 5 and the cooperative robot 3; and a servo gantry 9 configured to support the loader arm 7 at an upper side of an assembly object with which the heavy object D is to be assembled and to allow a planar movement of the loader arm 7 in a horizontal direction.

That is, in the assembly device of the present disclosure, when the gripper 1 grips the heavy object D to be assembled, the balancer 5 supports the weight of the gripper 1 and the weight of the heavy object D, and the cooperative robot 3 adjusts a precise position and a precise orientation of the heavy object D such that the heavy object D is precisely aligned on an assembly object B, so that a worker is capable of being easily assembling the heavy object D to the assembly object B.

Here, since a distance at which the heavy object D is capable of being moved is limited by the cooperative robot 3 alone, the loader arm 7 on which the gripper 1 and the cooperative robot 3 are mounted is capable of being moved to the servo gantry 9. Therefore, eventually, the heavy object D gripped on the gripper 1 is capable of being moved far enough for a smooth assembly operation.

That is, a working space and so on of the worker may be sufficiently secured between a pallet P on which the heavy object D is prepared and the assembly object B.

For reference, FIG. 1 is a view illustrating an overall

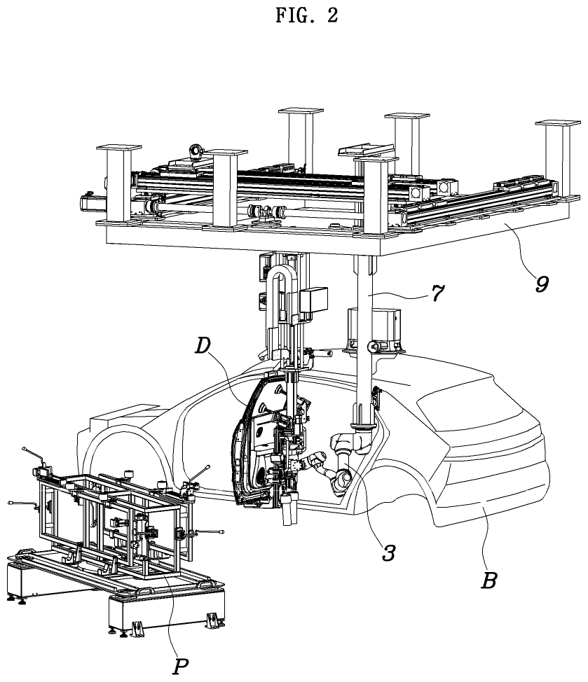

configuration of the heavy object D precision assembly device of the present disclosure, and a facility frame 11 supporting the servo gantry 9 is also displayed in FIG. 1. Furthermore, FIG. 2 is a view illustrating a configuration other than the facility frame 11 in FIG. 1.

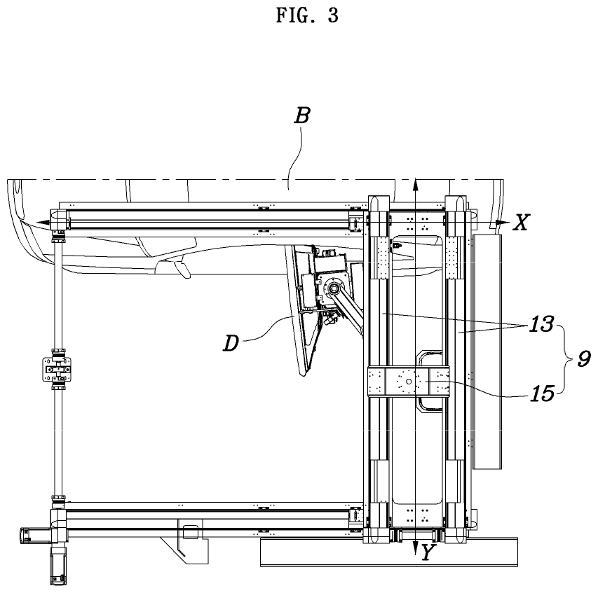

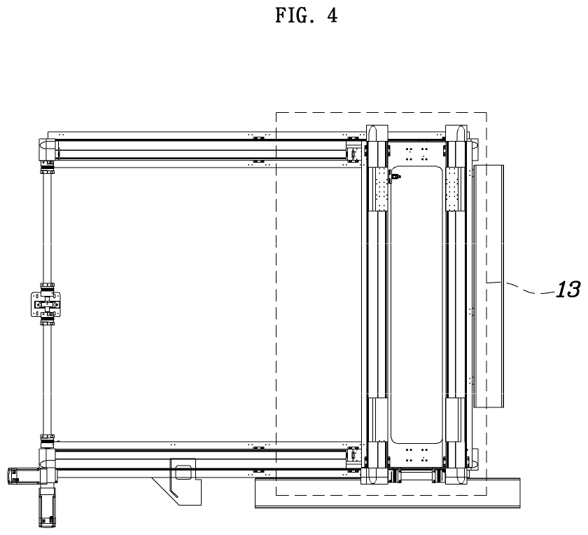

For reference, FIG. 3 and FIG. 4 are views illustrating the servo gantry 9 viewed from above. Furthermore, a first movement part 13 is capable of being moved in a first direction X, and a second movement part 15 is capable of being moved in a second direction Y with respect to the first movement part 13, so that the loader arm 7 connected to a lower side of the second movement part 15 is capable of performing the planar movement in the horizontal direction from above the heavy object D and the assembly object B.

The loader arm 7 has a lower end which extends downward of the servo gantry 9 and on which the cooperative robot 3 is mounted, and is connected to an upper side of the balancer 5 through a plurality of rotatable linkages 17 such that a planar movement in the horizontal direction of the balancer 5 is capable of being performed.

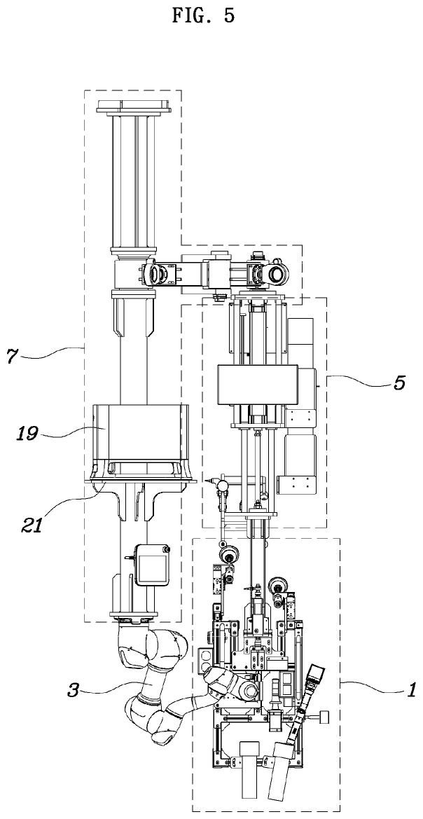

For reference, in FIG. 5, the loader arm 7 coupled to the lower side of the second movement part 15 of the servo gantry 9, the balancer 5 and the cooperative robot 3 that are mounted on the loader arm 7, and the gripper 1 mounted on the lower side of the balancer 5 are illustrated.

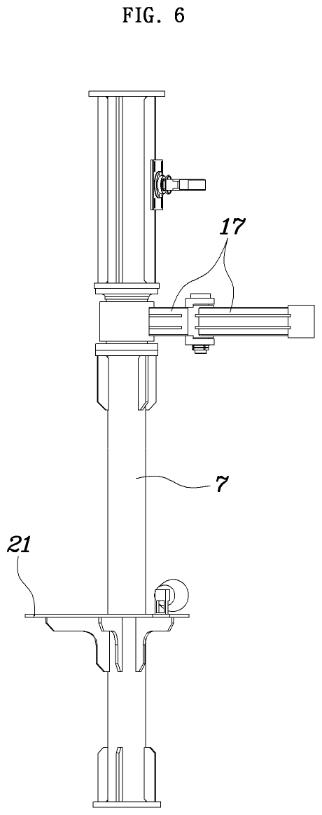

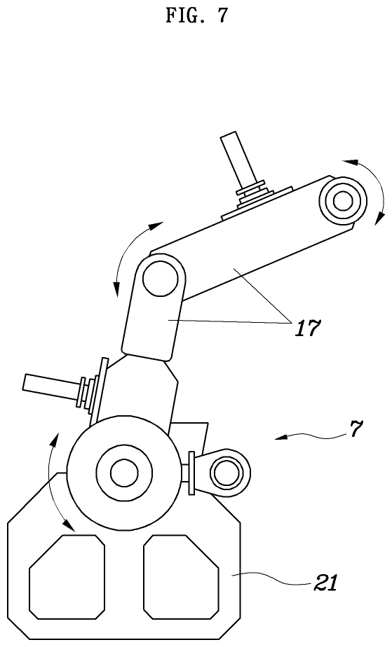

FIG. 6 is a view illustrating only the loader arm 7 in FIG. 5, and FIG. 7 is a view illustrating the loader arm 7 viewed from above. Furthermore, the linkages 17 connected to the upper side of the balancer 5 are connected between the loader arm 7 and the balancer 5 such that the linkages 17 are capable of being sequentially rotated with respect to each other, and the linkage 17 connected to the loader arm 7 is configured such that the linkage 17 is capable of being rotated with respect to the loader arm 7.

Therefore, when the balancer 5 performs the planar movement in the horizontal direction together with the gripper 1 by the cooperative robot 3, the linkages 17 are rotated so that the planar movement in the horizontal direction of the balancer 5 is capable of being performed.

Meanwhile, the loader arm 7 is provided integrally with a controller shelf 21 on which a robot controller 19 of the cooperative robot 3 is mounted. Furthermore, as illustrated in FIG. 5, the robot controller 19 is mounted on an upper side of the controller shelf 21.

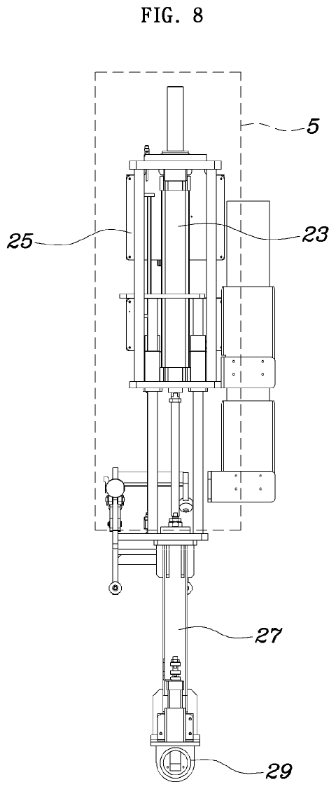

As illustrated in FIG. 8, the balancer 5 includes a cylinder 23 supporting the weight of the heavy object D that is gripped by the gripper 1, and includes an encoder 25 configured to detect an operation position of the cylinder 23.

Therefore, the gripper 1 mounted on the lower side of the balancer 5 is capable of performing a free position change in three-dimensional space by the planar movement in the horizontal direction due to the linkages 17 and by a vertical movement due to the cylinder 23.

The balancer 5 is configured such that a position hold mode controlled so as to follow the operation position of the cylinder 23 according to an input signal input to the balancer 5 is capable of being realized despite a change in an external force applied to the cylinder 23 in real time, and is configured such that a load guided mode controlled so as to change the operation position of the cylinder 23 according to a direction of an additional external force with respect to the external force that is already recognized is capable of being realized.

That is, in the position hold mode, the input signal keeps the position of the gripper 1 constant. Furthermore, when the heavy object D is gripped on the gripper 1 so that the weight the balancer 5 is required to support is increased or when the heavy object D gripped on the gripper 1 is released from the gripper 1 so that the weight the balancer 5 is required to support is decreased, the cylinder 23 is controlled such that the position of the gripper 1 remains constant.

In addition, in a situation in which the input signal is to raise or lower the gripper 1, when the weight the balancer 5 is required to support is changed in real time as the heavy object D is added or removed from the gripper 1, the gripper 1 is moved according to the input signal while such a situation is compensated in real time.

In addition, in the load guided mode, when an additional external force other than the weight that the balancer 5 already supports is applied, the operation position of the cylinder 23 is changed according to the direction of the external force. For example, in a state in which the gripper 1 is supported by the balancer 5, when the cooperative robot 3 moves the gripper 1 upward, the operation position of the cylinder 23 is raised accordingly, so that the gripper 1 is moved upward. Furthermore, when the cooperative robot 3 moves the gripper 1 downward, the operation position of the cylinder 23 is lowered accordingly, so that the gripper 1 is moved downward.

Of course, such an operation is performed in the same manner even when the gripper 1 is gripping the heavy object D.

That is, the load guided mode is a mode in which the cooperative robot 3 is capable of moving the gripper 1 as desired without bearing the weight of the gripper 1 or the weight of the heavy object D gripped on the gripper 1.

As described above, the balancer 5 supplements the payload of the cooperative robot 3, and performs a function that allows the cooperative robot 3 to smoothly adjust the position and the orientation of the heavy object D while the cooperative robot 3 having a relatively small payload is used.

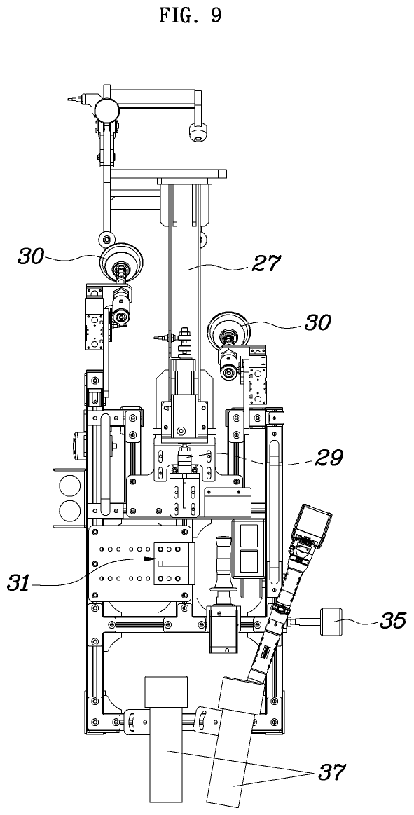

As illustrated in FIG. 9, the gripper 1 includes a gripper base 27 coupled to the lower side of the balancer 5, and includes a gripper operation part 31 connected to the gripper base 27 through a spherical bearing 29, the gripper operation part 31 being provided with a plurality of gripping apparatuses for gripping the heavy object D and being connected to the cooperative robot 3.

The gripper base 27 substantially serves to securely connect the gripper 1 to the lower side of the balancer 5, and serves to support the gripper operation part 31 with the spherical bearing 29.

Therefore, the gripper operation part 31 is capable of forming a free orientation by being rotated around the spherical bearing 29 by a control of the cooperative robot 3, so that the gripper operation part 31 is capable of freely adjusting the orientation of the heavy object D gripped by the gripping apparatus.

The heavy object D may be various components. In the embodiment, the heavy object D is a door of a vehicle, and the assembly object B is a vehicle body.

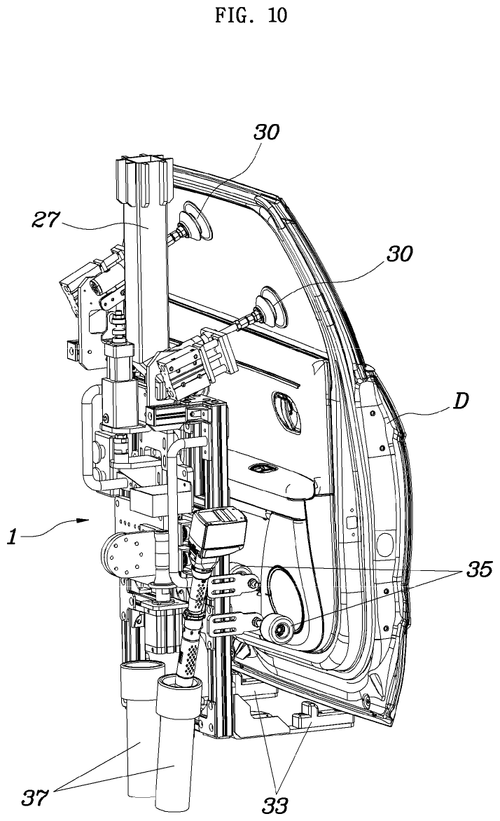

In this situation, the gripping apparatus may include at least one of a vacuum suction cup 30 suctioned to the glass of the door, a lower attachment 33 supporting a lower side of the door, and a trim attachment 35 supporting a trim of the door. In the present embodiment, as illustrated in FIG. 10, the vacuum suction cup 30, the lower attachment 33, and the trim attachment 35 are all provided.

Therefore, as illustrated in FIG. 10, in the door that is the heavy object D, the lower side of the door is supported by the lower attachment 33, the glass of the door is suctioned by the vacuum suction cup 30 from an upper side thereof, and the door trim at a middle side thereof is supported by the trim attachment 35. Therefore, as the door is integrated with the gripper 1, the door is gripped on the gripper 1 such that the position and the orientation of the door is changed together with the change in the position and the change in the orientation of the gripper 1.

Meanwhile, the gripper operation part 31 is provided with a tool holder 37 for mounting a tool of the worker assembling the heavy object D. Therefore, as the tool used by the worker is capable of being temporarily stored in the tool holder 37, the working convenience of the worker may be further increased.

The cooperative robot 3 is a multi-articulated robot having a six-axis degree of freedom. Furthermore, the cooperative robot 3 is configures such that an automatic driving mode in which the cooperative robot 3 is automatically operated according to a command that is taught from the robot controller 19 is realized, is configured such that a direct teaching mode in which a driving force and a brake of a robot driving shaft are released such that each driving shaft is capable of being rotated by an external force is realized, and is configured such that a force compliance control mode in which an orientation of the robot is changed according to an external force applied to the robot is realized.

In addition, the cooperative robot 3 is configured such that the operation of the cooperative robot 3 is stopped for protecting the worker when torque applied to the driving shaft exceeds a predetermined reference value, so that a safety accident caused by collision or entrapment with the worker may be prevented.

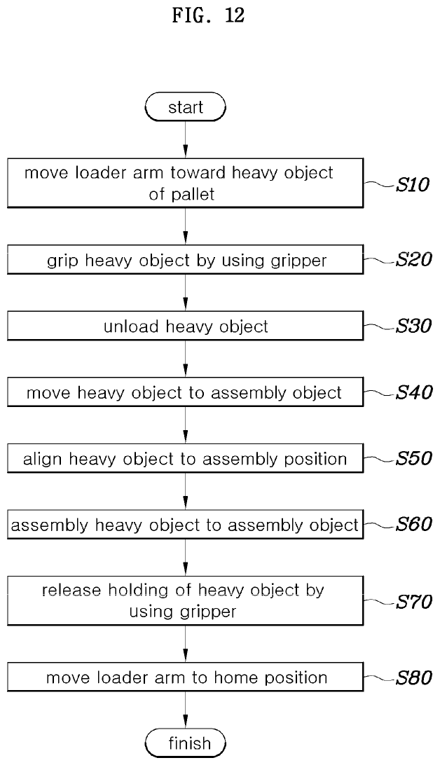

In addition, as illustrated in FIG. 12, a control method of such a heavy object precision assembly device includes: moving the loader arm 7 toward the heavy object D on the pallet P by using the servo gantry 9 (S10); gripping the heavy object D by using the gripper 1 supported on the loader arm 7 (S20); unloading the heavy object D from the pallet P by using the cooperative robot 3 (S30); moving, by using the servo gantry 9, the heavy object D to the assembly object B with which the heavy object D is to be assembled (S40); adjusting, according to a control of the worker by using the cooperative robot 3, a position and an orientation of the heavy object D gripped on the gripper 1, thereby aligning the heavy object D to an assembly position of the assembly object B (S50); releasing, by using the gripper 1, gripping of the heavy object D when an assembly of the heavy object D is completed (S70); and moving the loader arm 7 to a predetermined home position by using the servo gantry 9 (S70).

Here, the home position is an arbitrary position between the assembly object B and the pallet P on which the heavy object D is loaded, and may be set to a position where an interference with the worker is avoided and a process of replacing the assembly object B that has finished the assembly work with a new assembly object B may be smoothly performed.

For reference, the moving the loader arm 7 to the home position by using the servo gantry 9 (S70) may be omitted when the replacement and so on of the assembly object B is rapidly performed and the gripper 1 is immediately moved to the heavy object D of the pallet P after the gripping of the heavy object D that has been assembled is released.

Through the moving the loader arm 7 toward the heavy object D on the pallet P by using the servo gantry 9 (S10), the loader arm 7 is moved from the home position to a position where the heavy object D loaded on the pallet P is capable of being gripped.

In the gripping the heavy object D by using the gripper 1 (S20), when the gripper 1 grips the heavy object D, the mode of the cooperative robot 3 is switched from the automatic driving mode to the direct teaching mode, so that the load caused by the heavy object D is applied to the balancer 5.

In addition, the mode of the balancer 5 is switched from the load guided mode to the position hold mode, so that the balancer 5 is capable of additionally supporting the weight of the heavy object D in addition to the weight of the gripper 1.

When the heavy object D is the door of the vehicle, the door may be gripped on the gripper 1 by the vacuum suction cup 30 suctioned to the glass of the door, the lower attachment 33 supporting the lower side of the door, the trim attachment 35 supporting the trim of the door, and so on.

After the mode of the balancer 5 is switched from the load guided mode to the position hold mode and before the unloading the heavy object D from the pallet P (S30), a position adjustment for raising the heavy object D from the pallet P by a predetermined amount such that the weight of the heavy object D is capable of being fully supported by the balancer 5 may be performed.

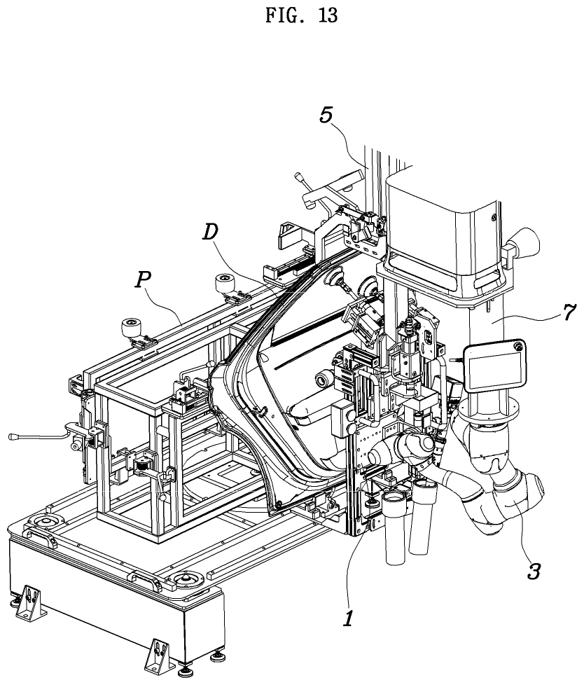

FIG. 13 is a view illustrating a state in which the position adjustment is performed such that the weight of the door is fully supported by the balancer 5 when the heavy object D is the door of the vehicle, and it can be seen in FIG. 13 that the lower side of the door is spaced apart from the pallet P.

When the position adjustment is performed, it is preferable that the predetermined amount of raising the heavy object D from the pallet P is set such that the heavy object D is sufficiently raised from the pallet P and the heavy object D is fully supported on the balancer 5 while the heavy object D is not significantly deviated from a state in which the heavy object D is supported on the pallet P.

In the unloading the heavy object D from the pallet P (S30), the mode of the balancer 5 is switched to the load guided mode and the mode of the cooperative robot 3 is switched to the automatic driving mode, and then the gripper 1 and the heavy object D are completely unloaded from the pallet P.

Then, through the moving, by using the servo gantry 9, the heavy object D to the assembly object B with which the heavy object D is to be assembled (S40), the heavy object D gripped on the gripper 1 is transported adjacent to the assembly position of the assembly object B.

In the aligning the heavy object D to the assembly position of the assembly object B (S50), the mode of the cooperative robot 3 is switched to the force compliance control mode, so that the position and the orientation of the heavy object D gripped on the gripper 1 are adjusted according to an external force applied by the worker.

Therefore, the worker moves the gripper 1 by hand such that the heavy object D transported adjacent to the assembly object B is aligned so that the heavy object D is in a state in which the heavy object D is capable of being assembled to the assembly object B. At this time, the mode of the cooperative robot 3 is in the force compliance control mode described above, and the cooperative robot 3 is capable of adjusting the position and the orientation of the gripper 1 by being in compliance with the force applied to the gripper 1 by the worker, so that the worker is capable of being easily aligning the heavy object D to the assembly position.

After the worker aligns the heavy object D to the assembly object B, the heavy object D is assembled to the assembly object B by using a bolt and so on (S60).

Here, when the heavy object D is the door and the assembly object B is the vehicle, the worker may align a door fastening hole of the door to a door hinge hole of the vehicle body, and fasten the bolt to the door fastening hole, thereby being capable of completing the assembly of the door to the vehicle body.

In the releasing the gripping of the heavy object D by using the gripper 1 (S70), the mode of the cooperative robot 3 is switched to the direct teaching mode, and the mode of the balancer 5 is switched to the position hold mode, so that only the weight of the gripper 1 is supported on the balancer 5.

Here, when the heavy object D is the door, the vacuum suction cup 30 may be controlled so as to release the glass of the door, and the cylinder 23 of the balancer 5 may slightly lower the operation position so that the weight of the door that has been assembled is no longer applied to the balancer 5.

After the releasing the gripping of the heavy object D by using the gripper 1 (S70), the moving the loader arm 7 to the home position by using the servo gantry 9 (S80) may be performed.

In the moving the loader arm 7 to the home position (S80), the mode of the balancer 5 is switched to the load guided mode, and the mode of the cooperative robot 3 is switched to the automatic driving mode, so that the gripper 1 is capable of being adjusted such that the gripper 1 is moved to a predetermined orientation of the home position.

The orientation of the home position may be an orientation in which the loader arm does not interfere with the adjacent worker or other objects when the loader arm is in the home position and which is convenient to be switched to an orientation for performing the gripping the heavy object D by using the gripper 1 (S20) that will be performed again.

Meanwhile, during performing all the processes from the moving the loader arm 7 toward the heavy object D (S10) to the moving the loader arm 7 to the home position (S80), when torque applied to the driving shaft of the cooperative robot 3 exceeds the predetermined reference value, the operation is stopped for the protection of the worker and an emergency alarm is generated, so that injury to the worker occurring when the worker is colliding with the cooperative robot 3 or the heavy object D and when the worker is trapped between the cooperative robot 3 and other objects may be effectively prevented.

### DESCRIPTION OF REFERENCE NUMERALS

1; gripper
3; cooperative robot
5; balancer
7; loader arm
9; servo Gantry
11; facility frame
13; first movement part
15; second movement part
17; linkage
19; robot controller
21; controller shelf
23; cylinder
25; encoder
27; gripper base
29; spherical bearing
30; vacuum suction cup
31; gripper operation part
33; lower attachment
35; trim attachment
37; tool holder
B; assembly object
D; heavy object
P; pallet

1. A heavy object precision assembly device comprising:
a gripper configured to grip a heavy object to be assembled;
a cooperative robot configured to adjust a position and an angle of the gripper;
a balancer configured to supplement a payload of the cooperative robot and to support the gripper;
a loader arm configured to support the balancer and the cooperative robot; and
a servo gantry configured to support the loader arm at an upper side of an assembly object with which the heavy object is to be assembled, the servo gantry being configured to allow the loader arm to perform a planar movement in a horizontal direction.

2. The heavy object precision assembly device of claim 1, wherein the loader arm has a lower end which extends downward of the servo gantry and on which the cooperative robot is mounted, and the loader arm is connected to an upper side of the balancer through a plurality of rotatable linkages such that a planar movement in the horizontal direction of the balancer is capable of being performed.

3. The heavy object precision assembly device of claim 2, wherein the loader arm is provided integrally with a controller shelf on which a robot controller of the cooperative robot is mounted.

4. The heavy object precision assembly device of claim 2, wherein the balancer comprises:
a cylinder configured to support the weight of the gripper and the weight of the heavy object that is gripped by the gripper; and
an encoder configured to detect an operation position of the cylinder.

5. The heavy object precision assembly device of claim 4, wherein the balancer is configured to realize:
a position hold mode controlled so as to follow the operation position of the cylinder according to an input signal despite a change in an external force applied to the cylinder in real time; and
a load guided mode controlled so as to change the operation position of the cylinder according to a direction of an additional external force with respect to an already recognized external force.

6. The heavy object precision assembly device of claim 1, wherein the gripper comprises:
a gripper base coupled to a lower side of the balancer; and
a gripper operation part connected to the gripper base by a spherical bearing, the gripper operation part being provided with a plurality of gripping apparatuses for gripping the heavy object and being connected to the cooperative robot.

7. The heavy object precision assembly device of claim 6, wherein the heavy object is a door of a vehicle, and the plurality of gripping apparatuses comprises at least one of a vacuum suction cup configured to be suctioned to glass of the door, a lower attachment configured to support a lower side of the door, and a trim attachment configured to support a trim of the door.

8. The heavy object precision assembly device of claim 6, wherein the gripper operation part is provided with a tool holder for mounting a tool of a worker, the tool being used for assembling the heavy object.

9. The heavy object precision assembly device of claim 1, wherein the cooperative robot is configured to realize:
an automatic driving mode in which the cooperative robot is automatically operated according to a command taught from a robot controller;
a direct teaching mode in which a driving force and a brake of a robot driving shaft are released such that each driving shaft is capable of being rotated by an external force; and
a force compliance control mode in which an orientation of the robot is changed according to an external force applied to the robot.

10. The heavy object precision assembly device of claim 9, wherein the cooperative robot is configured such that an operation of the cooperative robot is stopped for protecting a worker when torque applied to the driving shaft exceeds a predetermined reference value.

11. A heavy object precision assembly device control method comprising:
moving a loader arm toward a heavy object on a pallet by using a servo gantry;
gripping the heavy object by using a gripper supported on the loader arm;
unloading the heavy object from the pallet by using a cooperative robot;
moving, by using the servo gantry, the heavy object to an assembly object with which the heavy object is to be assembled;
adjusting, according to a control of a worker by using the cooperative robot, a position and an orientation of the heavy object gripped on the gripper, thereby aligning the heavy object to an assembly position of the assembly object; and
releasing, by using the gripper, gripping of the heavy object when an assembly of the heavy object is completed.

12. The heavy object precision assembly device control method of claim 11, further comprising moving the loader arm to a predetermined home position by using the servo gantry after the releasing gripping of the heavy object by using the gripper.

13. The heavy object precision assembly device control method of claim 11, wherein, in the gripping the heavy object by using the gripper, when the gripper grips the heavy object, a mode of the cooperative robot is switched from an automatic driving mode to a direct teaching mode so that a load caused by the heavy object is all applied on the balancer, and a mode of the balancer is switched from a load guided mode to a position hold mode so that the balancer is capable of additionally supporting the weight of the heavy object in addition to the weight of the gripper.

14. The heavy object precision assembly device control method of claim 13, wherein, after the mode of the balancer is switched from the load guided mode to the position hold mode and before the unloading the heavy object from the pallet, a position adjustment for raising the heavy object from the pallet by a predetermined amount such that the weight of the heavy object is capable of being fully supported by the balancer is performed.

15. The heavy object precision assembly device control method of claim 14, wherein, in the unloading the heavy object from the pallet, the mode of the balancer is switched to the load guided mode and the mode of the cooperative robot is switched to the automatic driving mode, and then the heavy object is completely unloaded from the pallet.

16. The heavy object precision assembly device control method of claim 11, wherein, in the aligning the heavy object to the assembly position of the assembly object, a mode of the cooperative robot is switched to a force compliance control mode, so that the position and the orientation of the heavy object gripped on the gripper are adjusted according to an external force applied by the worker.

17. The heavy object precision assembly device control method of claim 16, wherein, in the releasing gripping of the heavy object by the gripper, the mode of the cooperative robot is switched to a direct teaching mode and a mode of a balancer is switched to a position hold mode, so that only the weight of the gripper is supported on the balancer.

18. The heavy object precision assembly device control method of claim 17, wherein, after the releasing gripping of the heavy object by the gripper, moving the loader arm to a predetermined home position by using the servo gantry is performed, and
in the moving the loader arm to the predetermined home position, the mode of the balancer is switched to a load guided mode and the mode of the cooperative robot is switched to an automatic driving mode, so that the gripper is adjusted such that the gripper is moved to the predetermined home position.

19. The heavy object precision assembly device control method of claim 11, wherein the heavy object is a door of a vehicle, a vacuum suction cup that is a gripping apparatus of the gripper is suctioned to glass of the door during the gripping the heavy object by using the gripper, and the vacuum suction cup is released from the glass of the door during the releasing gripping of the heavy object by using the gripper.

20. The heavy object precision assembly device control method of claim 12, wherein, during performing all processes from the moving the loader arm toward the heavy object to the moving the loader arm to the home position, when torque applied to a driving shaft of the cooperative robot exceeds a predetermined reference value, an operation is stopped for protecting the worker.
